(19) United States
(12) Patent Application Publication
(10) Pub. No.: US 2026/0009437 A1
(43) Pub. Date: Jan. 8, 2026

(54) BRAKE ACTUATOR

(71) Applicants: ZF Active Safety US Inc., Livonia, MI (US); ZF Active Safety GmbH, Koblenz (DE)

(72) Inventors: Galus Chelaidite, South Lyon, MI (US); Kraig E. Gerber, Plymouth Township, MI (US); Lukas Madzgalla, Lahnstein (DE); Florian Roessinger, Neuwied (DE); Marco Becker, Oberduerenbach (DE)

(21) Appl. No.: 18/762,789

(22) Filed: Jul. 3, 2024

(51) Int. Cl. F16D 65/18; F16D 121/24; F16D 125/36; F16D 125/40; F16D 125/50

(52) U.S. Cl. CPC F16D 65/18; F16D 2121/24; F16D 2125/36; F16D 2125/40; F16D 2125/50

(57) ABSTRACT

A brake actuator (10) is specified, in particular for an electromechanical vehicle brake, having a brake caliper (12) in which an intermediate space (14) is formed for a brake rotor, wherein a brake pad (16), which can be applied against the brake rotor, is arranged in the intermediate space (14), a brake piston (18) for applying the brake pad (16) against the brake rotor, a spindle drive (20) which comprises a spindle (22) which is driven by an electric motor and a spindle nut (24) which is mounted on the spindle (22) via a thread pair which is designed to be self-releasing, and a ball ramp mechanism (28) which comprises a first ramp body (30) which is mounted fixedly in terms of rotation and which has an actuating surface (32) which is oriented toward the brake piston, and a second ramp body (34) which is arranged between the first ramp body (30) and the spindle nut (24). The spindle nut (24) is axially applied by means of a spring (35) against the second ramp body (34) and this second ramp body is axially applied against the first ramp body (30). The brake actuator (10) also comprises an electric motor which is coupled in terms of drive via a gear unit (26) to the spindle (22), in order to apply the brake piston (18) against the brake rotor (16).

### TECHNICAL FIELD

The invention relates to a brake actuator, in particular for an electromechanical vehicle brake.

### BACKGROUND

In vehicle brakes, brake actuators serve to apply a brake pad against a brake rotor. To this end, the brake actuator generally has an electric motor which is coupled in terms of drive via a gear unit and a spindle drive to a brake piston which can be selectively moved between a retracted position and an extended position for applying the brake pad against the brake rotor. In particular, an axial brake application force is transmitted from the brake piston to the brake pad in order to apply the brake pad against the brake rotor.

Over the course of time, the brake pad becomes worn by being repeatedly applied against the brake rotor. Specifically, abrasion occurs on the brake pad. As a result, the brake piston has to be extended further in order to generate a uniform brake application force.

In the case of a limited travel path of the brake piston, it is thus only possible to compensate for a defined degree of wear of the brake pad before a replacement of the brake pad is required. However, this is associated with high costs for the vehicle owner.

### SUMMARY

It is thus an object of the present invention to provide a brake actuator in which abrasion on the brake pad is compensated in an efficient manner.

This object is achieved according to the invention by a brake actuator, in particular for an electromechanical vehicle brake, having a brake caliper in which an intermediate space is formed for a brake rotor, wherein a brake pad, which can be applied against the brake rotor, is arranged in the intermediate space, as well as a brake piston for applying the brake pad against the brake rotor. Moreover, the brake actuator has a spindle drive which comprises a spindle which is driven by an electric motor and a spindle nut which is mounted on the spindle via a thread pair which is designed to be self-releasing, and a ball ramp mechanism which comprises a first ramp body which is mounted fixedly in terms of rotation and which has an actuating surface which is oriented toward the brake piston, and a second ramp body which is arranged between the first ramp body and the spindle nut, wherein the two ramp bodies have in each case on their opposing front faces at least one ball track which is concentric around an axis of rotation of the spindle and a ball is guided in the opposing ball tracks, wherein at least one of the ball tracks is configured as a ramp surface in which the depth of the ball track continuously changes so that, when one ramp body rotates relative to the other fixed ramp body, the first ramp body is displaced relative to the second ramp body. The spindle nut is axially applied by means of a spring against the second ramp body and this second ramp body is axially applied against the first ramp body. The brake actuator also comprises an electric motor which is coupled in terms of drive via a gear unit to the spindle, in order to apply the brake piston against the brake rotor.

An advantage of the brake actuator according to the invention is that it is possible to compensate for wear on the brake piston without this impairing a travel path of the brake piston. This leads to an extended service life of the brake actuator.

Due to the thread pair between the spindle nut and the spindle which is designed to be self-releasing, and at the same time the axial application of the spindle nut against the second ramp body which in turn is applied against the first ramp body, it is possible in a load-free state of the brake actuator, i.e. when the brake piston does not exert a brake application force on the brake pad, to advance the spindle nut on the spindle, in particular to displace the spindle nut toward the brake pad without the ball ramp mechanism being triggered. Specifically, in a load-free operation the spindle nut is held fixedly in terms of rotation by being axially applied against the second ramp body, which in turn is applied against the first fixed ramp body, while the spindle nut can be moved axially by a rotation of the spindle in order to compensate for the wear of the brake lining. The two ramp bodies and the brake piston are axially displaced together with the spindle nut. Only when the brake piston comes into contact with the brake pad and thus a load acts on the mechanism is the self-releasing property of the thread pair between the spindle and the spindle nut removed, and the spindle nut rotates together with the second ramp body when the spindle rotates, whereby the ball ramp mechanism is triggered and an axial brake application force is generated on the brake pad.

The spindle nut and the ball ramp mechanism are arranged in a sleeve which is guided in the brake caliper in a linearly displaceable manner and fixedly in terms of rotation. The spindle nut and the ball ramp mechanism can thus be handled as one unit, whereby the assembly of the brake actuator is simplified. In particular, the spindle nut and the ball ramp mechanism are captively received in the sleeve.

The spring is preferably also arranged in the sleeve.

More specifically, the spring can be tensioned between a radially inwardly protruding collar of the sleeve and the spindle nut. This also contributes to simplified handling during assembly.

The mounting of the first ramp body which is fixed in terms of rotation is implemented, in particular, by the first ramp body being received in the sleeve so as to be secured against rotation and the sleeve being secured against rotation in the brake piston. This also contributes to a compact design of the brake actuator.

For example, the sleeve has a collar, which is configured as an anti-rotation device, at its end in the vicinity of the brake pad. The collar has, for example, a flat edge and the first ramp body has a corresponding flat side which cooperates with the collar. As a result, the anti-rotation device between the sleeve and the first ramp body can be configured in a mechanically simple manner.

The collar, in particular, is bent back radially inwardly after the first ramp body has been arranged in the sleeve.

The sleeve, for example, is a sheet metal part with a radially protruding finger which protrudes into an axial groove in the brake piston and is axially displaceable therein. The brake piston can in turn be guided in an axial groove formed in the brake caliper in a non-rotatable and axially displaceable manner, in particular by means of a rotation-locking element arranged on the brake piston. As a result, the sleeve is guided indirectly via the brake piston in the brake caliper so as to be secured against rotation. This contributes to a compact design of the brake actuator since, as a result, the sleeve can be accommodated inside the brake piston and also a separate rotation-locking element is not required between the sleeve and the brake caliper.

The incline of the ball ramp mechanism and the thread pitch of the spindle are preferably identical. Due to the identical incline and pitch, the components of the mechanism operate synchronously, whereby the occurring loads are equally distributed. This can contribute to minimizing wear and thus increasing the service life of the brake actuator.

The spindle nut can have a cone which tapers axially toward the brake pad and on which the second ramp body is located with a mating cone. As a result, a sufficiently large contact surface is present between the spindle nut and the second ramp body in order to ensure an entrainment of the second ramp body by the spindle nut when operated under load, due to the friction acting between the two components.

The cone is formed, for example, from cone segments which are separated from one another by continuous radial slots. The cone segments are configured, in particular, to be resilient. As a result, the frictional force which occurs between the spindle nut and the second ramp body is increased further when operated under load.

The brake actuator can be configured as an actuator which can be actuated in two stages, having a first stage before a predetermined axial braking force has been reached and in which the spring pushes against the spindle nut such that the spindle nut is prevented from rotating when the spindle rotates, and as a result the spindle nut moves axially, and having a second stage after the predetermined axial braking force has been reached, after which the force exerted by the spring on the spindle is less than a frictional force produced in the thread between the spindle and the spindle nut, so that the spindle nut rotates together with the spindle and the spindle nut entrains the second ramp body and, as a result, the ball rolls along the ramp surfaces and moves the first ramp body and the brake piston further in the direction of the intermediate space. As already explained above, in a load-free state and with such a brake actuator it is possible to compensate for wear on the brake pad without the ball ramp mechanism being triggered.

The sleeve, the thread of the spindle and the ramp bodies are preferably fully received in the brake piston. In this manner, a compact design is implemented. Moreover, it is possible to dispense with corrosion protection for the components arranged in the brake piston.

The gear unit comprises, for example, a planetary gear unit, wherein a sun gear of the planetary gear unit is configured in one piece with the spindle. The number of components of the brake actuator is reduced thereby, which leads to a simplification of the assembly.

The spindle can have a radial flange on the motor-side end of the thread, the motor-side front face thereof being bulged outwardly. In addition, it is possible to provide a holding ring on which the spindle is axially supported and which has a complementary bearing surface. In this manner, a certain tiltability is possible between the radial flange of the spindle and the holding ring and transverse forces and bending moments in the brake actuator are substantially avoided, so that less wear occurs and, as a result, the service life of the brake actuator is increased. Since transverse forces are avoided, the axial bearings present in the brake actuator are also relieved of load. Force losses due to friction are also reduced, whereby an efficiency of the brake actuator is optimized.

### BRIEF DESCRIPTION OF THE DRAWINGS

Further advantages and features of the invention are found in the following description and in the accompanying drawings to which reference is made. In the drawings:

FIG. 1 shows a brake actuator according to the invention in a perspective sectional view,

FIG. 2 shows a first ramp body of the brake actuator,

FIG. 3 shows a second ramp body of the brake actuator,

FIG. 4 shows a sleeve of the brake actuator,

FIG. 5 shows a spindle nut of the brake actuator,

FIG. 6 shows a spindle of the brake actuator,

FIG. 7 shows the brake actuator in a load-free state, and

FIG. 8 shows the brake actuator in a loaded state.

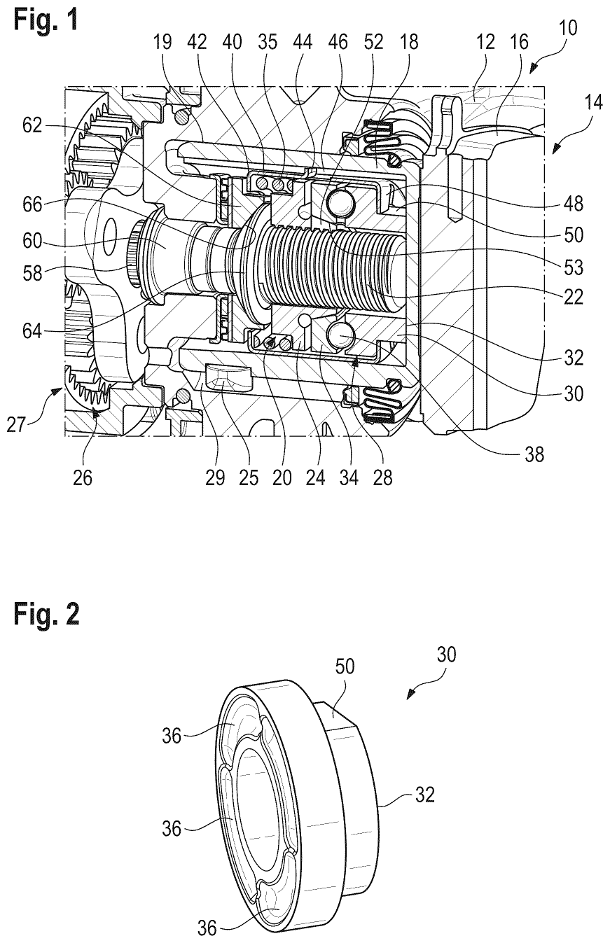

FIG. 1 shows a brake actuator 10 for an electromechanical vehicle brake.

### DESCRIPTION

The brake actuator 10 comprises a brake caliper 12 in which an intermediate space 14 is formed for a brake rotor, wherein a brake pad 16 which can be applied against the brake rotor is arranged in the intermediate space 14. The brake rotor is not shown in the figures for the sake of simplicity.

In addition, the brake actuator 10 comprises a brake piston 18 for applying the brake pad 16 against the brake rotor.

The brake piston 18 is received in a receiving space 19 in the brake caliper 12.

Moreover, the brake actuator 10 has a spindle drive 20 which in the exemplary embodiment is a threaded drive.

The spindle drive 20 comprises a spindle 22 which is driven by an electric motor and a spindle nut 24 which is mounted on the spindle 22 via a thread pair which is designed to be self-releasing.

An electric motor, which is not visible in the figures, is coupled in terms of drive via a gear unit 26 to the spindle 22, in order to apply the brake piston 18 against the brake rotor. In the exemplary embodiment, the gear unit 26 comprises a planetary gear unit 27.

As a result, the brake piston 18 can be moved by axial displacement between a retracted and an extended position.

The brake piston 18 is guided so as to be linearly displaceable and secured against rotation in the brake caliper 12, in particular by means of a rotation-locking element 25 which is mounted on the brake piston 18 and which is guided in an axial groove 29 in the brake caliper 12.

Moreover, the brake actuator 10 comprises a ball ramp mechanism 28.

The ball ramp mechanism 28 has a first ramp body 30 which is mounted fixedly in terms of rotation, having an actuating surface 32 which is oriented toward the brake piston 18, and a second ramp body 34 which is arranged between the first ramp body 30 and the spindle nut 24.

The two ramp bodies 30, 34 have in each case on their opposing front faces a plurality of, in particular four, ball tracks 36, 37 which are concentric around an axis of rotation of the spindle 22, wherein in each case a ball 38 is guided in the opposing ball tracks 36, 37.

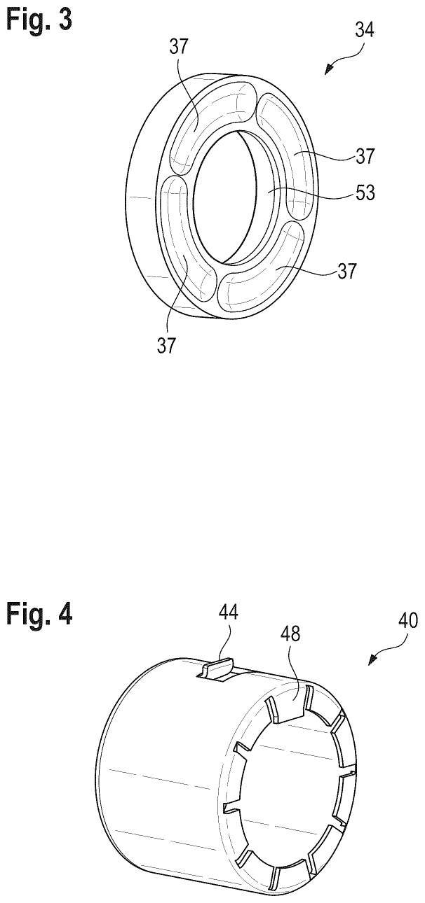

The ball tracks 36, 37 can be seen in FIGS. 2 and 3 which in each case show the first ramp body 30 and the second ramp body 34.

The ball tracks 36, 37 are configured as ramp surfaces in which the depth of the ball tracks 36, 37 continuously changes so that when the second ramp body 34 is rotated relative to the first fixed ramp body 30, the first ramp body 30 is displaced relative to the second ramp body 34.

As a result, the brake piston 18 is applied against the brake pad 16 and thus generates an axial brake application force.

In the exemplary embodiment, the incline of the ball ramp mechanism 28 and the thread pitch of the spindle 22 are identical.

The spindle nut 24 is axially applied by means of a spring 35 against the second ramp body 34 which in turn is axially applied against the first ramp body 30.

The spindle nut 24 and the ball ramp mechanism 28, in particular the first ramp body 30 and the second ramp body 34, are arranged in a sleeve 40 which is guided in the brake caliper 12 in a linearly displaceable manner and fixedly in terms of rotation.

The spring 35 is also arranged in the sleeve 40. Specifically, the spring 35 is tensioned between a radially inwardly protruding collar 42 of the sleeve 40 and the spindle nut 24.

In the exemplary embodiment, the sleeve 40 is a sheet metal part, in particular a deep-drawn part.

The sleeve 40 can be seen separately in FIG. 4.

The sleeve 40 is guided in the brake caliper 12, in particular in the brake piston 18, in a linearly displaceable manner and fixedly in terms of rotation.

To this end, the sleeve 40 has a radially protruding finger 44 which protrudes into an axial groove 46 in the brake piston 18 and is axially displaceable therein.

In the exemplary embodiment, the finger 44 is formed by a tab which has been punched out of the peripheral wall of the sleeve 40 and bent radially outwardly.

As a result, the sleeve 40 is guided in the brake caliper 12 in a linearly displaceable manner and fixedly in terms of rotation.

At its end in the vicinity of the brake pad 16, the sleeve 40 has a collar 48 which serves as an anti-rotation device for the first ramp body 30. The collar 48 is formed by a tab which is bent back radially inwardly.

To this end, the first ramp body 30 has a flattened portion 50 which cooperates with a straight edge of the collar 48.

The first ramp body 30 is thus received in the sleeve so as to be secured against rotation.

When considered as a whole, the ramp body 30 is arranged in the brake caliper 12 so as to be secured against rotation.

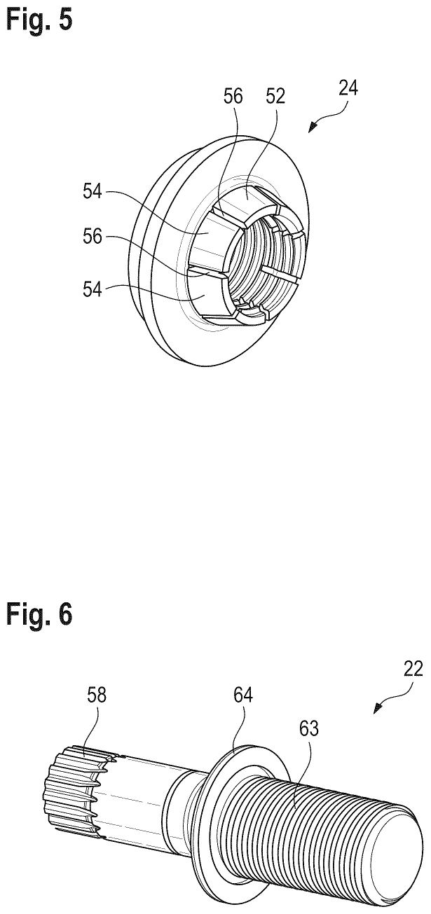

The spindle nut 24 of the brake actuator 10 is shown in FIG. 5.

The spindle nut 24 has a cone 52 which tapers axially toward the brake pad 16 and on which the second ramp body 34 is located with a mating cone 53.

The cone 52 is formed from a plurality of cone segments 54 which are separated from one another by continuous radial slots 56.

FIG. 6 shows the spindle 22 of the spindle drive 20.

The spindle 22 is configured in one piece with a sun gear 58 of the planetary gear unit 27.

As can be seen in FIG. 1, the spindle 22 is supported in the brake caliper 12 via a radial bearing 60.

A holding ring 62 is also present, the spindle 22 being axially supported thereon.

To this end, the spindle 22 has a radial flange 64 which bears against the holding ring 62, on the motor-side end of the thread 63 of the spindle 22.

The motor-side end of the flange 64 is bulged outwardly as can be seen in FIG. 1. The holding ring 62 has a correspondingly complementary bearing surface 66. A certain tiltability of the spindle 22 relative to the holding ring 62 is possible due to the bulged front face of the flange 64.

In the exemplary embodiment, the thread 63 of the spindle 22, the sleeve 40 and the ramp bodies 30, 34 are fully received in the brake piston 18.

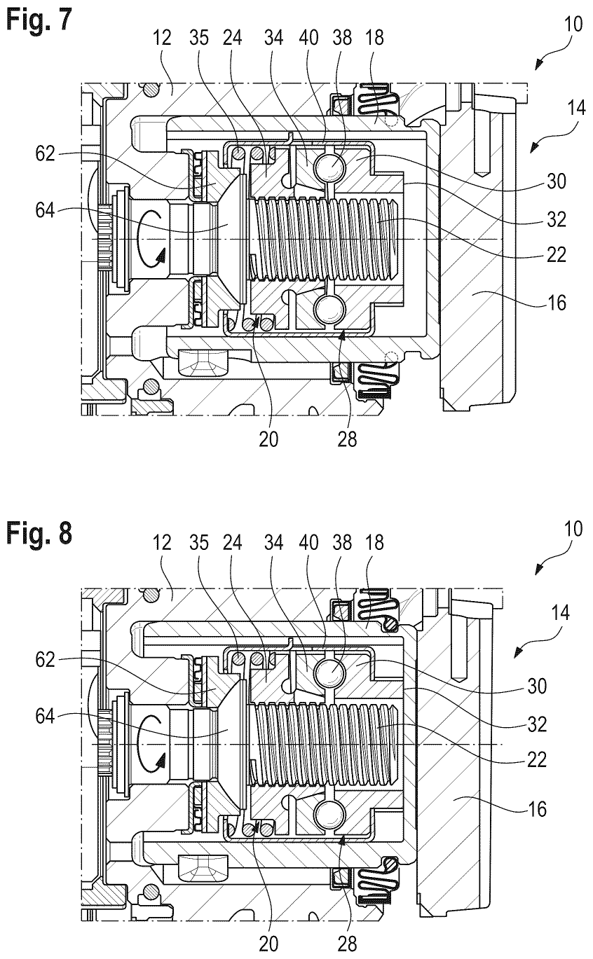

Hereinafter, the mode of operation of the brake actuator 10 is explained in more detail on the basis of FIGS. 7 and 8.

The described brake actuator 10 is configured as an actuator which can be actuated in two stages.

A first stage is illustrated in FIG. 7. A load-free state is present here. This means that a predetermined axial braking force has not yet been reached.

For example, in the first state the brake piston 18 does not generate an axial brake application force on the brake pad 16.

In this state, the first ramp body 30 can be spaced apart from the inner face of the brake piston 18 by its actuating surface 32.

In this state, the spring 35 pushes against the spindle nut 24 such that the spindle nut is prevented from rotating when the spindle rotates. In this state, the axial spring force is greater, in particular, than the friction between the spindle 22 and the spindle nut 24 which, as already explained above, is coupled to the spindle 22 via a thread pair designed to be self-releasing.

In this state, if the spindle 22 rotates, the spindle nut 24 moves axially, whereby the sleeve 40 with the components arranged therein, in particular the two ramp bodies 30, 34 and the spring 35, are moved in the direction of the brake pad 16. The ball ramp mechanism 28 is not triggered thereby.

In this manner, it is possible to compensate for the wear of the brake pad 16 caused by abrasion, in particular the wear of a brake lining.

In a second stage, a loading state is present after the predetermined axial braking force has been reached.

After the predetermined braking force has been reached, the force exerted by the spring 35 on the spindle 22 is less than a frictional force acting in the thread between the spindle 22 and the spindle nut 24. In other words, the spindle nut 24 is wedged with the spindle 22 by the axial brake application force of the brake piston 18.

As a result, the spindle nut 24 rotates with the spindle 22.

The spindle nut 24 entrains the second ramp body 34 and thereby triggers the ball ramp mechanism 28 due to the frictional force acting on the cone surface between the spindle nut 24 and the second ramp body 34.

Specifically, the balls 38 roll along the ramp surfaces due to the rotation of the second ramp body 34, whereby the first ramp body 30 and the brake piston 18 are moved further in the direction of the intermediate space 14 and thus a brake application force is generated on the brake pad 16.

1. A brake actuator (10), in particular for an electromechanical vehicle brake, having
a brake caliper (12) in which an intermediate space (14) is formed for a brake rotor, wherein a brake pad (16), which can be applied against the brake rotor, is arranged in the intermediate space (14),
a brake piston (18) for applying the brake pad (16) against the brake rotor,
a spindle drive (20) which comprises a spindle (22) which is driven by an electric motor and a spindle nut (24) which is mounted on the spindle (22) via a thread pair which is designed to be self-releasing,
a ball ramp mechanism (28) which comprises a first ramp body (30) which is mounted fixedly in terms of rotation and which has an actuating surface (32) which is oriented toward the brake piston, and a second ramp body (34) which is arranged between the first ramp body (30) and the spindle nut (24), wherein the two ramp bodies (30, 34) have in each case on their opposing front faces at least one ball track (36, 37) which is concentric around an axis of rotation of the spindle (22) and a ball (38) is guided in the opposing ball tracks (36, 37), wherein at least one of the ball tracks (36, 37) is configured as a ramp surface in which the depth of the ball track (36, 37) continuously changes so that, when one ramp body (34) rotates relative to the other fixed ramp body (30), the first ramp body (30) is displaced relative to the second ramp body,
wherein the spindle nut (24) is axially applied by means of a spring (35) against the second ramp body (34) and this second ramp body is axially applied against the first ramp body (30), and
having an electric motor which is coupled in terms of drive via a gear unit (26) to the spindle (22), in order to apply the brake piston (18) against the brake rotor (16).

2. The brake actuator (10) as claimed in claim 1, wherein the spindle nut (24) and the ball ramp mechanism (28) are arranged in a sleeve (40) which is guided in the brake caliper (12) in a linearly displaceable manner and fixedly in terms of rotation.

3. The brake actuator (10) as claimed in claim 2, wherein the spring (35) is tensioned between a radially inwardly protruding collar (42) of the sleeve (40) and the spindle nut (24).

4. The brake actuator (10) as claimed in claim 2, wherein the first ramp body (30) is received in the sleeve (40) so as to be secured against rotation and the sleeve (40) is secured against rotation in the brake piston (18).

5. The brake actuator (10) as claimed in claim 4, wherein the sleeve (40) has a collar (48), which is configured as an anti-rotation device, at its end in the vicinity of the brake pad (16).

6. The brake actuator (10) as claimed in claim 2, wherein the sleeve (40) is a sheet metal part with a radially protruding finger (44) which protrudes into an axial groove (46) in the brake piston (18) and is axially displaceable therein.

7. The brake actuator (10) as claimed in claim 1, wherein the incline of the ball ramp mechanism (28) and the thread pitch of the spindle (22) are identical.

8. The brake actuator (10) as claimed in claim 1, wherein the spindle nut (24) has a cone (52) which tapers axially toward the brake pad (16) and on which the second ramp body (34) is located with a mating cone (53).

9. The brake actuator (10) as claimed in claim 8, wherein the cone (52) is formed from cone segments (54) which are separated from one another by continuous radial slots (56).

10. The brake actuator (10) as claimed in claim 1, wherein the brake actuator (10) is configured as an actuator which can be actuated in two stages, having a first stage before a predetermined axial braking force has been reached and in which the spring (35) pushes against the spindle nut (24) such that the spindle nut is prevented from rotating when the spindle (22) rotates, and as a result the spindle nut (24) moves axially, and having a second stage after the predetermined axial braking force has been reached, after which the force exerted by the spring (35) on the spindle (22) is less than a frictional force produced in the thread between the spindle (22) and the spindle nut (24), so that the spindle nut (24) rotates together with the spindle (22) and the spindle nut (24) entrains the second ramp body (34) and, as a result, the ball (38) rolls along the ramp surfaces and moves the first ramp body (30) and the brake piston (18) further in the direction of the intermediate space (14).

11. The brake actuator (10) as claimed in claim 1, wherein the thread of the spindle (22), the sleeve (40) and the ramp bodies (30, 34) are fully received in the brake piston (18).

12. The brake actuator (10) as claimed in claim 1, wherein the gear unit (26) comprises a planetary gear unit (27), wherein a sun gear (58) of the planetary gear unit (27) is configured in one piece with the spindle (22).

13. The brake actuator (10) as claimed in claim 1, wherein the spindle (22) has a radial flange (64) on the motor-side end of the thread, the motor-side front face thereof being bulged outwardly, and a holding ring (62) on which the spindle (22) is axially supported and which has a complementary bearing surface.
